(19) United States
(12) Patent Application Publication
(10) Pub. No.: US 2011/0025698 A1
(43) Pub. Date: Feb. 3, 2011

(54) PROCESS MANAGEMENT SYSTEM

(75) Inventor: JYH-GWO JU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/609,220

(22) Filed: Oct. 30, 2009

(30) Foreign Application Priority Data
Jul. 30, 2009 (CN) 200910305011.X

(51) Int. Cl. G06T 15/00; G06F 9/46

(52) U.S. Cl. 345/522; 718/100

(57) ABSTRACT

A process management system includes a display, a process handling module and a plurality of window process modules. The process handling module includes a process manager sub-module and a process table sub-module. The window process modules communicate with the process handling module, and each window process module processes one function on the display. The process manager sub-module terminates an executing window process module before starting another window process module. The process table sub-module manages and records a processed history of the window process modules.

### CROSS-REFERENCE TO RELATED APPLICATIONS

Relevant subject matter is disclosed in co-pending U.S. patent applications entitled “PROCESS MANAGEMENT SYSTEM”, Attorney Docket No. US28171.

### BACKGROUND

1. Technical Field

The present disclosure relates to a process management system and, particularly, to a process management system on an embedded device.

2. Description of Related Art

Embedded devices, for example, digital photo frames (DPFs) are becoming increasingly popular due to their convenience and ease of manipulation when implementing particular functions. However, if the embedded device has only one window application, all window functions (for example, video, photo) are integrated in the window application. Every time a user needs a window function (for example, browsing photos), the window application with all window functions is started up. The window application will consume more system resources.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a process management system.

FIG. 2 is a block view of a process handling module.

FIG. 3 is a schematic view of a process management system.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

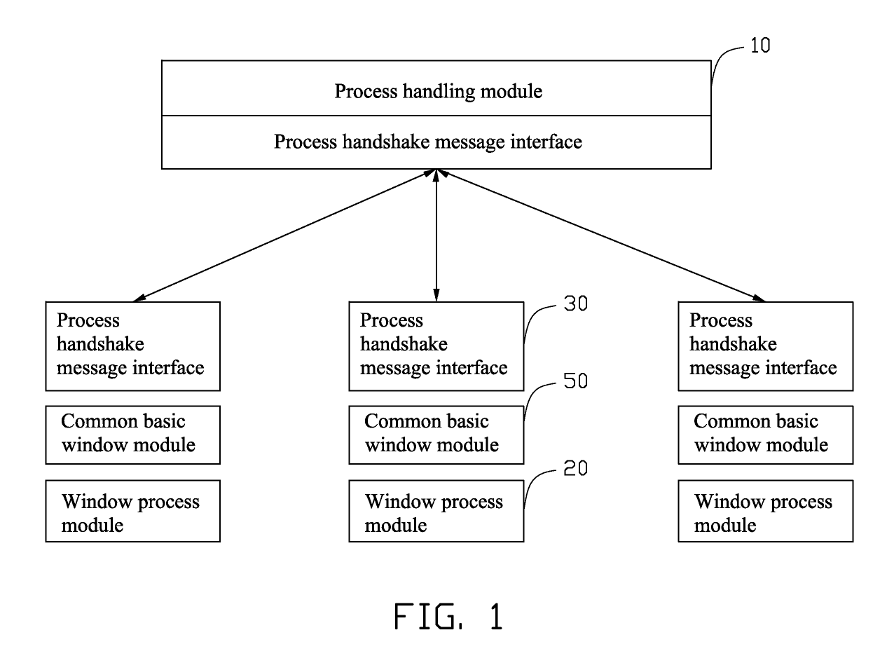

Referring to FIG. 1, a process management system includes a process handling module 10, a plurality of window process modules 20 and a display showing each window process module 20. The process handling module 10 has a process handshake message interface 30 to communicate with the window process module 20 based on a unified standardizing protocol.

The window process modules 20 communicate with the process handling module 10 through the process handshake message interface 30 and a common basic window module 50. The common basic window module provides a common basic function for the window process module 20. The window process module 20 may be a video window module a photo window module, or a radio window module. The video window module is capable of playing videos for users. The users view photos through the photo window module. The users listen to radios through the radio window module.

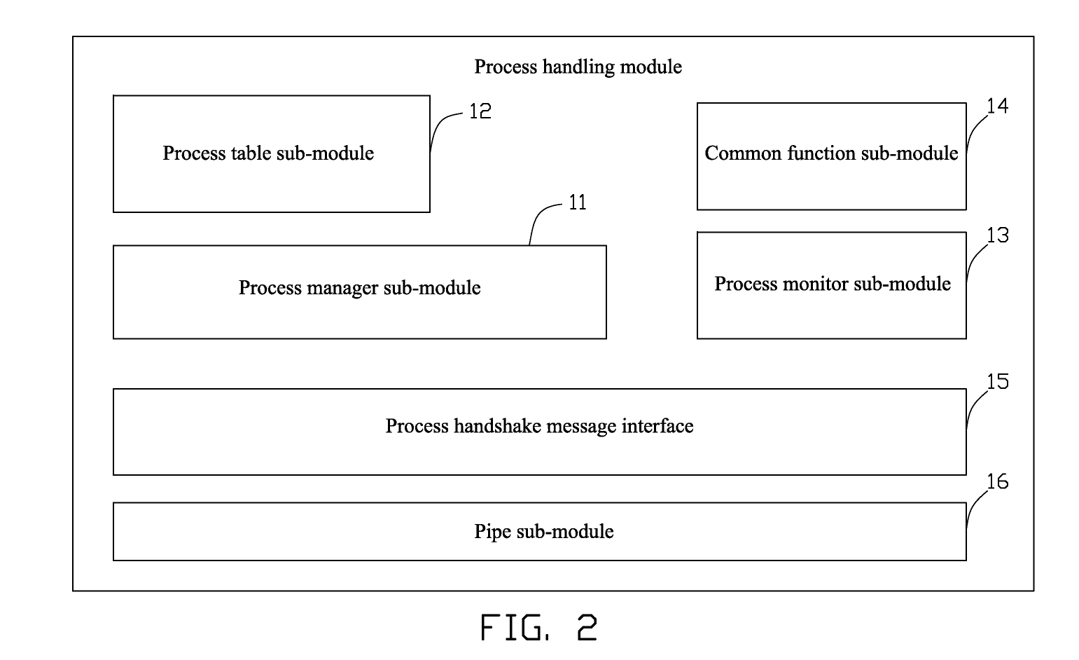

Referring to FIG. 2, the process handling module 10 includes a process manager sub-module 11, a process table sub-module 12, a process monitor sub-module 13, a common function sub-module 14, a process handshake message interface 15, and a pipe sub-module 16.

The process manager sub-module 11 can terminate the executing window process module 20 before the process manager sub-module 10 starts another window process module 20. The process table sub-module 12 manages and records the window process modules 20. All processed window process modules 20 are recorded in the process table sub-module 12.

The process monitor sub-module 13 monitors the window process module 20. The process monitor sub-module 13 notifies the process handling module 10 to restart the window process module 20 when the window process module 20 is not running correctly. The common function sub-module 14 executes common functions of the window process modules 20. For example, all the window process modules 20 have mute functions. The common function sub-module 14 may execute mute functions. It reduces application codes of the window process modules 20.

The process handshake message interface 15 communicates with the window process module 20 by a standardizing protocol. The pipe sub-module 16 sends messages to the window process module 20 or receives the messages from the window process module 20 in a unified message format.

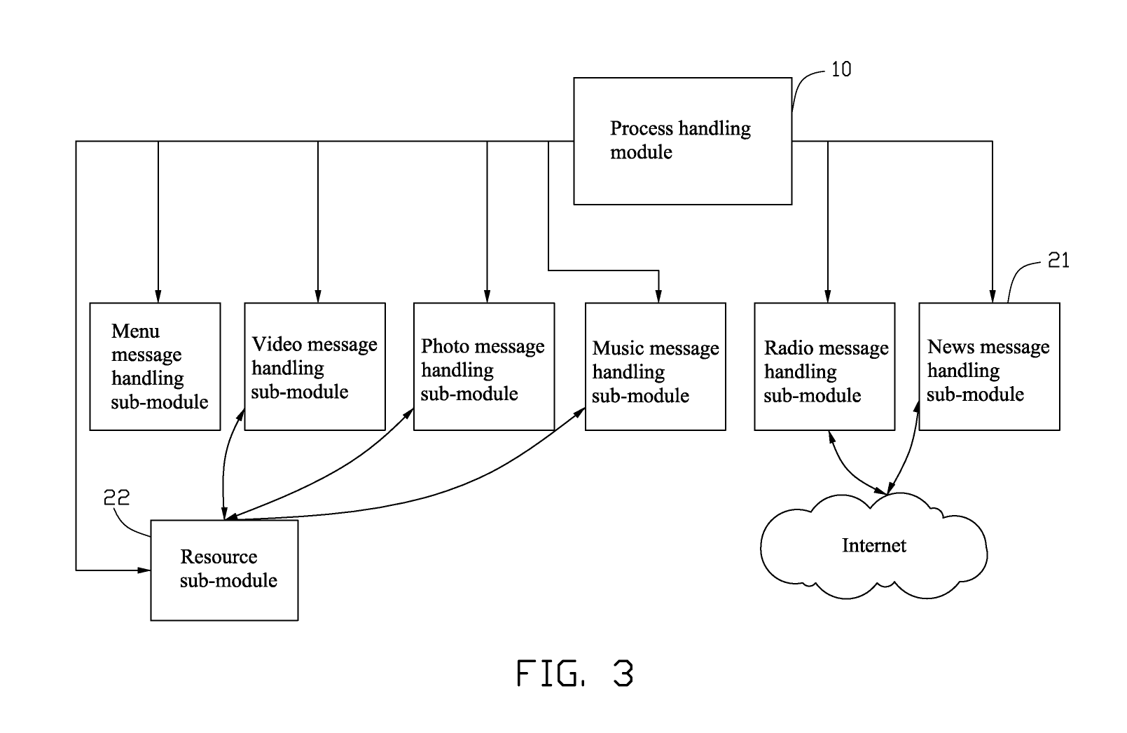

Referring to FIG. 3, the window process module 20 includes a message handling sub-module 21 and a resource sub-module 22. The message handling sub-module 21 receives messages from the process handling module 10 and connects to the resource sub-module 22 for retrieving resources.

The message handling sub-module 21 may be a video sub-module, a photo sub-module, a radio sub-module, and so on. The resource sub-module 22 may be a video resource, a photo resource, an Internet radio resource, and so on.

The process handling module 10 starts up the window process module 20. The process handling module 10 sends a check message to the window process module 20 to determine if the window process module 20 is running correctly. The window process module 20 sends “ok” response message to the process handling module 10. When the window process module 20 runs normally, the resources from the resource sub-module 22 show on the display.

The window process module 20 sends terminate message to the process handling module 10. The process handling module 10 sends a stop response message to the window process module 20 to stop the window process module 20. Then the process handling module 10 starts another window process module 20.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A process management system, comprising:
a display;
a process handling module comprising a process manager sub-module and a process table sub-module;
a plurality of window process modules being capable of communicating with the process handling module, and each window process module being capable of processing one function on the display; wherein the process manager sub-module is capable of terminating an executing window process module before starting another window process module, and the process table sub-module is capable of managing and recording a processed history of the window process modules.

2. The process management system of claim 1, wherein the process handling module further comprises a process monitor sub-module capable of monitoring the window process module running status.

3. The process management system of claim 1, wherein the process handling module further comprises a common function sub-module capable of executing common functions of the window process modules.

4. The process management system of claim 1, wherein the process handling module further comprises a process handshake message interface capable of communicating with the window process module.

5. The process management system of claim 4, wherein the process handshake message interface is capable of communicating with the window process module by a standardizing protocol.

6. The process management system of claim 1, wherein the process handling module further comprises a pipe sub-module capable of sending messages to the window process module.

7. The process management system of claim 6, wherein the pipe sub-module is capable of sending messages to the window process module in a unified message format.

8. The process management system of claim 1, wherein the window process module is a multimedia player module.

9. The process management system of claim 1, wherein the window process module is a network window module.

10. The process management system of claim 1, wherein the window process module comprises a resource sub-module capable of linking to a resource.

11. A process management system, comprising:
a display;
a process handling module comprising a process manager sub-module and a process monitor sub-module;
a plurality of window process modules capable of communicating with the process handling module, and each window process module being capable of processing one function on the display; wherein the process manager sub-module is capable of stopping an executing window process module before the process manager sub-module starting another window process module, and the process monitor sub-module is capable of monitoring the window process module running status.

12. The process management system of claim 11, wherein the process handling module further comprises a process table sub-module capable of managing and recording the window process modules.

13. The process management system of claim 11, wherein the process handling module further comprises a common function sub-module capable of executing common functions of the window process modules.

14. The process management system of claim 11, wherein the process handling module further comprises a process handshake message interface capable of communicating with the window process module.

15. The process management system of claim 14, wherein the process handshake message interface is able to communicate with the window process module by a standardizing protocol.

16. The process management system of claim 11, wherein the process handling module further comprises a pipe sub-module capable of sending messages to the window process module.

17. The process management system of claim 16, wherein the pipe sub-module capable of sending messages to the window process module in a unified message format.

18. The process management system of claim 11, wherein the window process module is a multimedia player module.

19. The process management system of claim 11, wherein the window process module is a network window module.

20. The process management system of claim 11, wherein the window process module comprises a resource sub-module capable of linking to a resource showing on the display.
